(19) United States
(12) Patent Application Publication
(10) Pub. No.: US 2005/0188128 A1
(43) Pub. Date: Aug. 25, 2005

(54) Data transfer apparatus

(75) Inventor: Masatoshi Koshiba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/113,196

(22) Filed: Apr. 25, 2005

Related U.S. Application Data
(63) Continuation of application No. PCT/JP03/05984, filed on May 14, 2003.

(51) Int. Cl. G06F 13/14

(52) U.S. Cl. 710/40

(57) ABSTRACT

Peripheral circuits each have a buffer connected to a common bus and output respective data transfer requests depending on the amount of data of the buffer. A data transfer circuit performs data transfer between a memory circuit and the buffer in response to the data transfer request. Each low-speed peripheral circuit of the peripheral circuits except a high-speed peripheral circuit having the largest transfer rate outputs the respective data transfer requests when a predetermined time has elapsed after the amount of data of the buffer became the amount sufficient to output the data transfer request. The high-speed peripheral circuit outputs a data transfer request when a time shorter than the predetermined time has elapsed after the amount of data of the buffer became the amount sufficient to output the data transfer request. Consequently, data that must be transferred within a predetermined period can be reliably transferred.

### CROSS-REFERENCE TO RELATED APPLICATIONS

This application is a continuation of PCT International Application No. PCT/JP03/05984, filed on May 14, 2003, the entire contents of which are incorporated herein by reference.

### BACKGROUND OF THE INVENTION

1. Field of the Invention

The present invention relates to a data transfer apparatus for exchanging data using a direct memory access (DMA) transfer scheme.

2. Description of the Related Art

Generally, a data transfer apparatus has a DMA transfer function of directly exchanging data between a peripheral circuit and a memory via a bus, without an intervening of a central processing unit (CPU) between the peripheral circuit and the memory, so as to transfer mass data at a high speed, although the CPU intervenes in a software transfer (program transfer). The DMA transfer is performed by a DMA controller (DMAC). Upon receiving a DMA transfer request from the peripheral circuit, the DMAC requests the CPU to release the bus. When the bus can be released, the CPU hands over the use of the bus to the DMAC, and thus turning the bus into high impedance. The DMAC transfers data from the peripheral circuit (or the memory) requesting the DMA transfer to the memory (or the peripheral circuit requesting the DMA transfer) via the bus. The DMAC returns the use of the bus to the CPU concurrently with ending of the DMA transfer.

Generally, the DMAC has a plurality of channels for performing the DMA transfer independently and the plurality of channels has their own priorities. For example, upon receiving a DMA transfer request to a channel having a high priority when a channel having a low priority performs a DMA transfer, the DMAC controls the channel having the high priority to perform the DMA transfer after the channel having the low priority has completed the DMA transfer in the minimal unit of a transfer block. When the channel having the high priority has completed the DMA transfer, the DMAC controls the channel having the low priority to perform the DMA transfer again. For example, it is generally indispensable to transfer moving picture data used for display of a moving picture in a predetermined period of time. Accordingly, the DMA transfer of the moving picture data is achieved when the DMA transfer is assigned to the channel having the high priority.

However, if an access time (data read time or data write time) to the peripheral circuit that outputs a request for the DMA transfer assigned to the channel having the low priority is long, that is, if a transfer rate is small, the following problems may occur. In the course of performing the DMA transfer of the channel having the low priority, although the channel having the high priority is requested the DMA transfer of the moving picture data as described above, the channel having the low priority cannot immediately stop the DMA transfer. On this account, object data of the DMA transfer of the channel having the high priority may not be transferred within a predetermined period of time. As a result, the moving picture may not be normally displayed.

In addition, when the DMA transfer request to the channel having the high priority occurs frequently, the DMA transfer request to the channel having the low priority may not be accepted by the channel having the low priority. In other words, the channel having the low priority may not perform the DMA transfer even when it receives the DMA transfer request.

On the other hand, Japanese Unexamined Patent Application Publication No. 5-134977 discloses a method of bringing out the maximum transfer capacity of a bus and changing data transfer speed of each of a plurality of communication control adaptors when a DMA transfer is performed via the bus in a system including a CPU and the plurality of communication control adaptors connected to the CPU via the bus.

### SUMMARY OF THE INVENTION

Accordingly, an object of the present invention is to provide a data transfer apparatus, which is capable of reliably transferring data that must be transferred within a predetermined period of time.

Another object of the present invention is to provide a data transfer apparatus, which is capable of reliably performing data transfer in response to any data transfer request from any peripheral circuit.

According to one aspect of the data transfer apparatus of the present invention, the data transfer apparatus includes a common bus used for data transfer, a memory circuit to which data is transferred via the common bus, a plurality of peripheral circuits, and a data transfer circuit. The respective peripheral circuits have respective buffers connected to the common bus and output respective data transfer requests depending on the amount of data of the respective buffers. The data transfer circuit performs data transfer between the memory circuit and a corresponding buffer of the respective buffers in response to the data transfer request. Each low-speed peripheral circuit of the peripheral circuits except a high-speed peripheral circuit having the largest transfer rate outputs the data transfer request when a predetermined time has elapsed after the amount of data of the corresponding buffer became the amount sufficient to output the data transfer request. The high-speed peripheral circuit outputs a data transfer request when a time shorter than the predetermined time has elapsed after the amount of data of the corresponding buffer became the amount sufficient to output the data transfer request.

Since the low-speed peripheral circuit delays the timing at which the data transfer request is output by the predetermined time, the data transfer circuit can receive the data transfer request from the high-speed peripheral circuit beforehand, which would originally be received after the data transfer request from the low-speed peripheral circuit is received. Accordingly, the data transfer responding to the data transfer request from the low-speed peripheral circuit can be exchanged with the data transfer responding to the data transfer request from the high-speed peripheral circuit. As a result, even when a transfer request of data that must be transferred within a predetermined period of time is output from the high-speed peripheral circuit, the data can be reliably transferred.

According to another aspect of the data transfer apparatus of the present invention, each of the low-speed peripheral circuits has a register for setting the predetermined time, and outputs the data transfer request when the predetermined time set in the register has elapsed after the amount of data of the corresponding buffer became the amount sufficient to output the data transfer request.

By providing the register for the respective peripheral circuits, the predetermined time can be varied. Accordingly, the data transfer can cope with change of transfer rates of the low-speed peripheral circuits and change of the number of receivable data transfer requests in the data transfer circuit.

According to yet another aspect of the data transfer apparatus of the present invention, the data transfer circuit preferentially performs data transfer responding to a data transfer request having the highest priority and rotates the priorities of the data transfer requests whenever the data transfer is performed by a predetermined amount. More specifically, the data transfer circuit controls a channel, which performed the data transfer, to have the lowest priority and other remaining channels to have high priorities whenever the data transfer is performed by the predetermined amount. Accordingly, in response to any data transfer request from any peripheral circuit, the data transfer can be reliably performed.

According to yet another aspect of the data transfer apparatus of the present invention, the predetermined time until the low-speed peripheral circuit outputs the data transfer request is set to be longer as a transfer rate of the low-speed peripheral circuit becomes smaller. Accordingly, the data transfer responding to the data transfer request from the low-speed peripheral circuit having a large transfer rate can be prevented from being delayed due to an effect of the data transfer responding to the data transfer request from the low-speed peripheral circuit having a small transfer rate.

According to yet another aspect of the data transfer apparatus of the present invention, the high-speed peripheral circuit outputs the data transfer request immediately after the amount of data of the corresponding buffer becomes the amount sufficient to output the data transfer request. Accordingly, the data transfer responding to the data transfer request from the high-speed peripheral circuit can be prevented from being delayed uselessly.

According to yet another aspect of the data transfer apparatus of the present invention, the data transfer circuit is a direct memory access controller for performing the data transfer by a direct memory access transfer. Even when the data transfer circuit is constituted by the direct memory access controller, the data that must be transferred within a predetermined period of time can be reliably transferred.

According to yet another aspect of the data transfer apparatus of the present invention, a peripheral circuit, which has a buffer to which data is written by the data transfer, recognizes that the data transfer request is to be output when the amount of data of the buffer becomes smaller than a predetermined amount. Accordingly, the buffer can be prevented from being empty. As a result, the amount of data of the buffer can be optimally controlled, and accordingly, malfunction of the peripheral circuits can be prevented.

According to yet another aspect of the data transfer apparatus of the present invention, a peripheral circuit, which has a buffer from which data is read by the data transfer, recognizes that the data transfer request is to be output when the amount of data of the buffer becomes larger than the predetermined amount. Accordingly, the buffer can be prevented from overflowing. As a result, the amount of data of the buffer can be optimally controlled, and accordingly, malfunction of the peripheral circuits can be prevented.

According to yet another aspect of the data transfer apparatus of the present invention, the data of the buffer of the high-speed peripheral circuit is moving picture data. Accordingly, the moving picture data that must be generally transferred within a predetermined period of time can be reliably transferred.

According to yet another aspect of the data transfer apparatus of the present invention, the data of the buffer of the high-speed peripheral circuit is audio data. Accordingly, the audio data that must be generally transferred within a predetermined period of time can be reliably transferred.

According to yet another aspect of the data transfer apparatus of the present invention, the peripheral circuits and the data transfer circuit are formed on separate semiconductor chips. Even when the peripheral circuits and the data transfer circuit are formed on the separate semiconductor chips, the data that must be transferred within a predetermined period of time can be reliably transferred.

According to yet another aspect of the data transfer apparatus of the present invention, the peripheral circuits and the data transfer circuit are formed on the same semiconductor chip. Even when the peripheral circuits and the data transfer circuit are formed on the same semiconductor chip, the data that must be transferred within a predetermined period of time can be reliably transferred.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram illustrating a data transfer apparatus according to a first embodiment of the present invention;

FIG. 2 is an explanatory diagram illustrating an example of a DMA transfer according to the first embodiment;

FIG. 3 is an explanatory diagram illustrating another example of a DMA transfer according to the first embodiment; and

FIG. 4 is a block diagram illustrating a data transfer apparatus according to a second embodiment of the present invention.

### DESCRIPTION OF THE PREFERRED EMBODIMENTS

Hereinafter, embodiments of the present invention will be described with reference to the accompanying drawings.

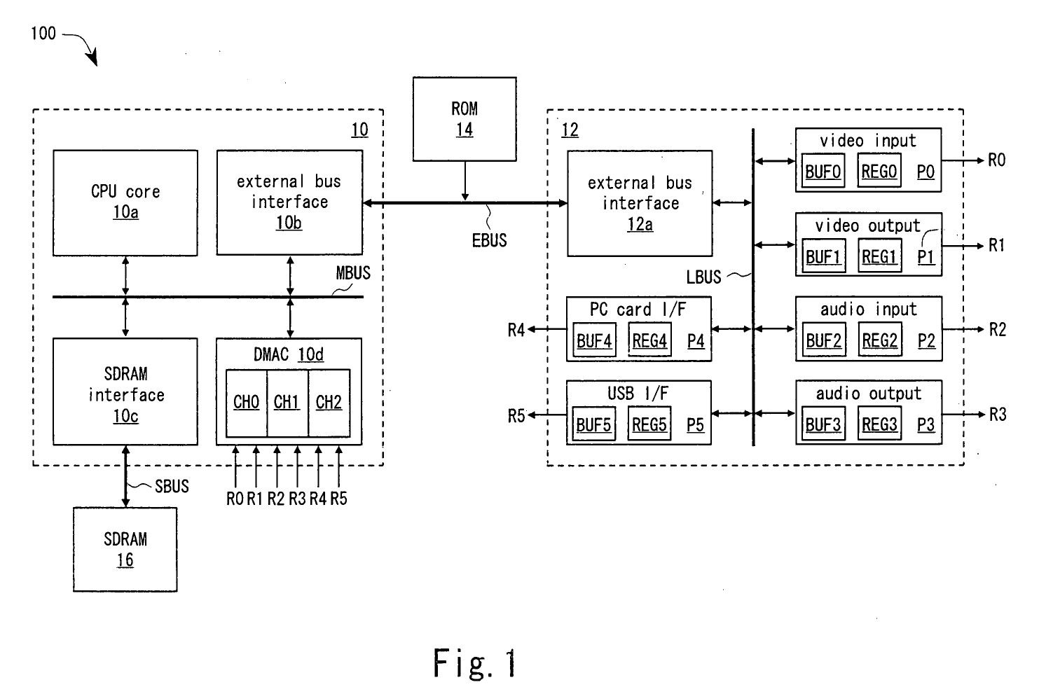

FIG. 1 is a block diagram illustrating a data transfer apparatus according to a first embodiment of the present invention.

A data transfer apparatus 100 includes semiconductor chips 10 and 12, a ROM 14, a SDRAM 16 (memory circuit), an external bus EBUS, and a bus SBUS for exclusive use of SDRAM.

The semiconductor chip 10 includes a CPU core 10a, an external bus interface 10b, a SDRAM interface 10c, a DMAC 10d (data transfer circuit), and a main bus MBUS.

The CPU core 10a controls components of the data transfer apparatus 100 based on a program stored in the ROM 14 and performs various arithmetic processes. The external bus interface 10b serves as an interface for exchanging data with the ROM 14 or the semiconductor chip 12. The SDRAM interface 10c serves as an interface for exchanging data with the SDRAM 16.

The DMAC 10d includes channels CH0 to CH2 for performing a DMA transfer independently. A start factor of each of the channels CH0 to CH2 can be set by one of DMA transfer requests R0 to R5. Each of the channels CH0 to CH2 performs the DMA transfer between a buffer of one of peripheral circuits P0 to P5 to output an assigned DMA transfer request and the SDRAM 16, in response to the assigned DMA transfer request. The channels CH0 to CH2 have priorities whose levels become higher as a channel number becomes lower, that is, priorities indicated by a relationship of CH0>CH1>CH2, as initial values. In the DMAC 10d, a channel having the highest priority performs the DMA transfer most preferentially.

The DMAC 10d rotates the priorities among the channels whenever the DMA transfer is performed by a preset amount. More specifically, the DMAC 10d controls a channel which performed the DMA transfer to have a low priority and other remaining channels to have high priorities, whenever the DMA transfer is performed by the preset amount.

The main bus MBUS interconnects the CPU core 10a, the external bus interface 10b, the SDRAM interface 10c, and the DMAC 10d to make possible the data exchange therebetween.

The semiconductor chip 12 includes an external bus interface 12a, the peripheral circuits P0 to P5, and a local bus LBUS (common bus).

The external bus interface 12a serves as an interface for exchanging data with the semiconductor chip 10.

The peripheral circuit P0 serving as an input circuit of a video signal circuit includes a buffer BUF0 and a register REG0, which are connected to the local bus LBUS. A value of the register REG0 can be arbitrarily set. The peripheral circuit P0 stores moving picture data generated from the video signal supplied from a video input terminal (not shown) into the buffer BUF0. When the amount of data of the buffer BUF0 exceeds a predetermined amount, the peripheral circuit P0 recognizes that the data transfer request R0 is to be output, and actually outputs the data transfer request R0 after a predetermined time preset in the register REG0 elapses.

A channel to which the data transfer request R0 in the DMAC 10d is assigned reads the data from the buffer BUF0 and writes the read data into the SDRAM 16 by the DMA transfer via the bus SBUS for exclusive use of SDRAM, the main bus MBUS, the external bus EBUS, and the local bus LBUS, in response to the data transfer request R0.

The peripheral circuit P1 serving as an output circuit of the video signal includes a buffer BUF1 and a register REG1, which are connected to the local bus LBUS. A value of the register REG1 can be arbitrarily set. The peripheral circuit P1 generates the video signal from the moving picture data stored in the buffer BUF1 and outputs the generated video signal from a video output terminal (not shown). When the amount of data of the buffer BUF1 becomes smaller than a predetermined amount, the peripheral circuit P1 recognizes that the data transfer request R1 is to be output, and actually outputs the data transfer request R1 after a predetermined time preset in the register REG1 elapses.

A channel to which the data transfer request R1 in the DMAC 10d is assigned reads the data from the SDRAM 16 and writes the read data into the buffer BUF1 by the DMA transfer via the bus SBUS for exclusive use of SDRAM, the main bus MBUS, the external bus EBUS, and the local bus LBUS, in response to the data transfer request R1.

The peripheral circuit P2 serving as an input circuit of an audio signal includes a buffer BUF2 and a register REG2, which are connected to the local bus LBUS. A value of the register REG2 can be arbitrarily set. The peripheral circuit P2 stores audio data generated from the audio signal supplied from an audio input terminal (not shown) into the buffer BUF2. When the amount of data of the buffer BUF2 exceeds a predetermined amount, the peripheral circuit P2 recognizes that the data transfer request R2 is to be output, and actually outputs the data transfer request R2 after a predetermined time preset in the register REG2 elapses.

A channel to which the data transfer request R2 in the DMAC 10d is assigned reads the data from the buffer BUF2 and writes the read data into the SDRAM 16 by the DMA transfer via the bus SBUS for exclusive use of SDRAM, the main bus MBUS, the external bus EBUS, and the local bus LBUS, in response to the data transfer request R2.

The peripheral circuit P3 serving as an output circuit of the audio signal includes a buffer BUF3 and a register REG3, which are connected to the local bus LBUS. A value of the register REG3 can be arbitrarily set. The peripheral circuit P3 generates the audio signal from the audio data stored in the buffer BUF3 and outputs the generated audio signal from an audio output terminal (not shown). When the amount of data of the buffer BUF3 becomes smaller than a predetermined amount, the peripheral circuit P3 recognizes that the data transfer request R3 is to be output, and actually outputs the data transfer request R3 after a predetermined time preset in the register REG3 elapses.

A channel to which the data transfer request R3 in the DMAC 10d is assigned reads the data from the SDRAM 16 and writes the read data into the buffer BUF3 by the DMA transfer via the bus SBUS for exclusive use of SDRAM, the main bus MBUS, the external bus EBUS, and the local bus LBUS, in response to the data transfer request R3.

The peripheral circuit P4 serving as a PC card interface pursuant to PCMCIA (Personal Computer Memory Card International Association) 2.1/JEIDA (Japan Electronic Industry Development Association) 4.2 includes a buffer BUF4 and a register REG4, which are connected to the local bus LBUS. A value of the register REG4 can be arbitrarily set. When data is read from a PC card inserted in a PC card slot (not shown), the peripheral circuit P4 stores the data read from the PC card into the buffer BUF4. When the amount of data of the buffer BUF4 exceeds a predetermined amount, the peripheral circuit P4 recognizes that the data transfer request R4 is to be output, and actually outputs the data transfer request R4 after a predetermined time preset in the register REG4 elapses.

A channel to which the data transfer request R4 in the DMAC 10d is assigned reads the data from the buffer BUF4 and writes the read data into the SDRAM 16 by the DMA transfer via the bus SBUS for exclusive use of SDRAM, the main bus MBUS, the external bus EBUS, and the local bus LBUS, in response to the data transfer request R4.

The peripheral circuit P5 serving as a USB (Universal Serial Bus) interface pursuant to USB 1.1 includes a buffer BUF5 and a register REG5, which are connected to the local bus LBUS. A value of the register REG5 can be arbitrarily set. When data is transferred to a USB (not shown), the peripheral circuit P5 transmits the data stored in the buffer BUF5 to the USB. When the amount of data of the buffer BUF5 becomes smaller than a predetermined amount, the peripheral circuit P5 recognizes that the data transfer request R5 is to be output, and actually outputs the data transfer request R5 after a predetermined time preset in the register REG5 elapses.

A channel to which the data transfer request R5 in the DMAC 10d is assigned reads the data from the SDRAM 16 and writes the read data into the buffer BUF5 by the DMA transfer via the bus SBUS for exclusive use of SDRAM, the main bus MBUS, the external bus EBUS, and the local bus LBUS, in response to the data transfer request R5.

The local bus LBUS interconnects the external bus interface 12a and the peripheral circuits P0 to P5 to make possible the data exchanges therebetween.

The SDRAM 16 temporarily stores programs executed by the CPU core 10a or data under an arithmetic process. The external bus EBUS interconnects the semiconductor chips 10 and 12 and the ROM 14 to make possible the data exchange therebetween. The bus SBUS for exclusive use of SDRAM interconnects the semiconductor chip 10 and the SDRAM 16 to make possible the data exchange therebetween.

Hereinafter, operation of the data transfer apparatus 100 will be described.

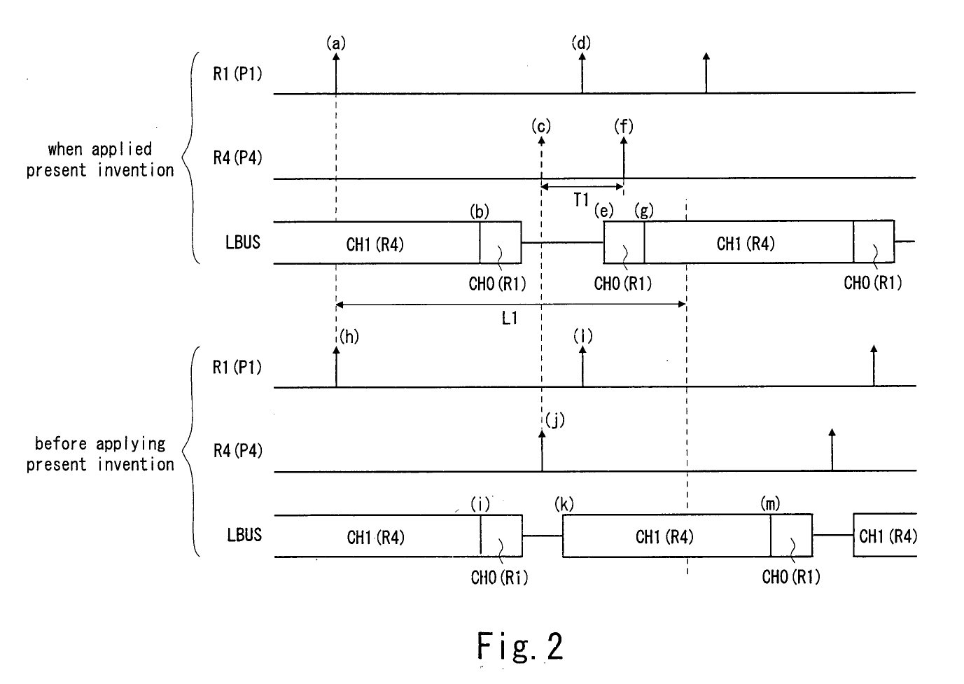

FIG. 2 illustrates an example of the DMA transfer when the peripheral circuits P1 and P4 are operated.

The DMA transfer requests R1 and R4 are assigned to the channels CH0 and CH1, respectively. Since the data of the buffer BUF1 of the peripheral circuit P1 is the moving picture data, the channel CH0 is requested a high-speed DMA transfer and is required to complete the DMA transfer twice within a predetermined period of time L1. Since the data of the buffer BUF4 of the peripheral circuit P4 is the data read from the PC card, the channel CH1 performs the DMA transfer with no restriction on time and without the high-speed DMA transfer being requested.

In addition, a transfer rate of the peripheral circuit P1 is much larger than a transfer rate of the peripheral circuit P4. That is, a time required for the DMA transfer performed by the channel CH1 is much longer than a time required for the DMA transfer performed by the channel CH0. In other words, the peripheral circuit P1 acts as a high-speed peripheral circuit and the peripheral circuit P4 acts as a low-speed peripheral circuit.

An example of the DMA transfer in the data transfer apparatus 100 according to the present invention is shown in an upper portion in FIG. 2. At a point of time (a) in FIG. 2, the peripheral circuit P1 recognizes that the amount of data of the buffer BUF1 becomes smaller than the predetermined amount during the DMA transfer of the channel CH1, and outputs the DMA transfer request R1 immediately. Here, the value of the register REG1 is preset to 0, which is smaller than a predetermined time T1. At a point of time (b) in FIG. 2, the local bus LBUS is occupied for the DMA transfer of the channel CH0 after the DMA transfer of the channel CH1 is completed.

At a point of time (c) in FIG. 2, the peripheral circuit P4 recognizes that the amount of data of the buffer BUF4 becomes larger than the predetermined amount. However, the peripheral circuit P4 does not output the DMA transfer request R4 until the predetermined time T1 elapses. Here, the value of the register REG4 is preset to the predetermined time T1. At a point of time (d) in FIG. 2, the peripheral circuit P1 recognizes that the amount of data of the buffer BUF1 becomes smaller than the predetermined amount, and outputs the DMA transfer request R1 immediately. At a point of time (e) in FIG. 2, the local bus LBUS is occupied for the DMA transfer of the channel CH0. In this way, the channel CH0 can complete the DMA transfer twice within the predetermined period of time L1.

At a point of time (f) in FIG. 2, the peripheral circuit P4 recognizes the elapse of the predetermined time T1 and outputs the DMA transfer request R4. At a point of time (g) in FIG. 2, the local bus LBUS is occupied for the DMA transfer of the channel CH1 after the DMA transfer of the channel CH0 is completed. In addition, the DMAC 10d rotates the priorities among the channels whenever the data transfer is performed by a predetermined amount. On this account, at a point of time (f) in FIG. 2, even if the data transfer request R4 competes with the data transfer request R1, the DMAC 10d controls the channel CH1 to perform the DMA transfer. Accordingly, in response to any data transfer request assigned to the channels CH0 and CH1, the DMA transfer can be reliably performed.

An example of the DMA transfer before the present invention is applied to the DMA transfer is shown in a lower portion in FIG. 2. As shown in the figure, when the peripheral circuit P4 recognizes that the amount of data of the buffer BUF4 becomes smaller than the predetermined amount, it outputs the DMA transfer request R4 immediately. At a point of time (h) in FIG. 2, the peripheral circuit P1 recognizes that the amount of data of the buffer BUF1 becomes smaller than the predetermined amount during the DMA transfer of the channel CH1, and outputs the DMA transfer request R1 immediately. At a point of time (i) in FIG. 2, the local bus LBUS is occupied for the DMA transfer of the channel CH0 after the DMA transfer of the channel CH1 is completed.

At a point of time (j) in FIG. 2, the peripheral circuit P4 recognizes that the amount of data of the buffer BUF4 becomes smaller than the predetermined amount during the DMA transfer of the channel CH1, and outputs the DMA transfer request R4 immediately. At a point of time (k) in FIG. 2, the local bus LBUS is occupied for the DMA transfer of the channel CH1.

At a point of time (l) in FIG. 2, the peripheral circuit P1 recognizes that the amount of data of the buffer BUF1 becomes smaller than the predetermined amount during the DMA transfer of the channel CH1, and outputs the DMA transfer request R1 immediately. At a point of time (m) in FIG. 2, the local bus LBUS is occupied for the DMA transfer of the channel CH0 after the DMA transfer of the channel CH1 is completed. Accordingly, the channel CH0 cannot complete the DMA transfer twice within the predetermined period of time L1. That is, the video signal output from the video output terminal is stopped.

As described above, by delaying the timing at which the peripheral circuit P4 outputs the DMA transfer request R4 by the predetermined time T1, the DMAC 10d can receives the DMA transfer request R1 beforehand, which would originally be received after the DMA transfer request R4 is received. Accordingly, the DMA transfer performed by the channel CH1 is exchanged with the DMA transfer performed by the channel CH0. As a result, the channel CH0 reliably completes the DMA transfer twice within the predetermined period of time L1.

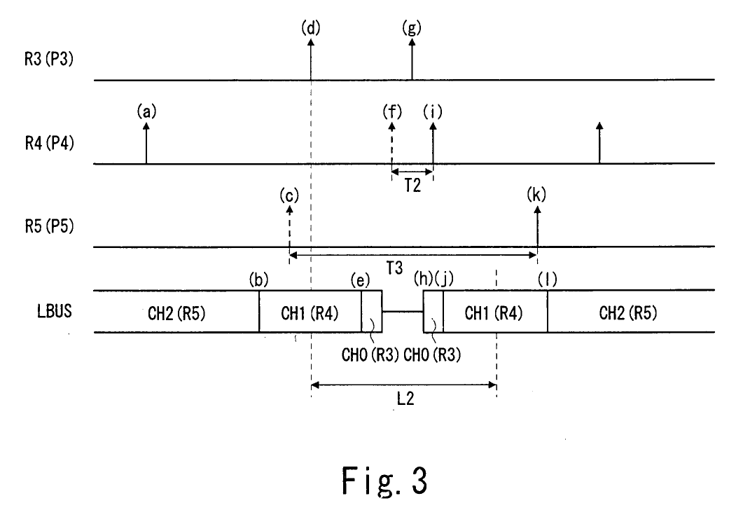

FIG. 3 illustrates an example of the DMA transfer when the peripheral circuits P3, P4 and P5 are operated.

The DMA transfer requests R3, R4 and R5 are assigned to the channels CH0, CH1 and CH2, respectively. Since the data of the buffer BUF3 of the peripheral circuit P3 is the audio data, the channel CH0 is requested a high-speed DMA transfer and is required to complete the DMA transfer twice within a predetermined period of time L2. Since the data of the buffer BUF4 of the peripheral circuit P4 is the data read from the PC card, the channel CH1 performs the DMA transfer with no restriction on time and without the high-speed DMA transfer being requested. Since the data of the buffer BUF5 of the peripheral circuit PS is the data transmitted to the UBS, the channel CH2 performs the DMA transfer with no restriction on time and without the high-speed DMA transfer being requested as compared to the channel CH1.

In addition, a transfer rate of the peripheral circuit P3 is much larger than a transfer rate of the peripheral circuit P4. That is, a time required for the DMA transfer performed by the channel CH1 is much longer than a time required for the DMA transfer performed by the channel CH0. A transfer rate of the peripheral circuit PS is much smaller than the transfer rate of the peripheral circuit P4. That is, a time required for the DMA transfer performed by the channel CH2 is much longer than a time required for the DMA transfer performed by the channel CH1. In other words, the peripheral circuit P3 acts as a high-speed peripheral circuit and the peripheral circuits P4 and PS act as a low-speed peripheral circuit.

At a point of time (a) in FIG. 3, the peripheral circuit P4 outputs the DMA transfer request R4 during the DMA transfer of the channel CH2. At a point of time (b) in FIG. 3, the local bus LBUS is occupied for the DMA transfer of the channel CH1 after the DMA transfer of the channel CH2 is completed.

At a point of time (c) in FIG. 3, the peripheral circuit PS recognizes that the amount of data of the buffer BUF5 becomes smaller than a predetermined amount. However, the peripheral circuit PS does not output the DMA transfer request R5 until a predetermined time T3 elapses. Here, the value of the register REG5 is preset to the predetermined time T3. At a point of time (d) in FIG. 3, the peripheral circuit P3 outputs the DMA transfer request R3 during the DMA transfer of the channel CH1. At a point of time (e) in FIG. 3, the local bus LBUS is occupied for the DMA transfer of the channel CH0 after the DMA transfer of the channel CH1 is completed.

At a point of time (f) in FIG. 3, the peripheral circuit P4 recognizes that the amount of data of the buffer BUF4 becomes larger than a predetermined amount. However, the peripheral circuit P4 does not output the DMA transfer request R4 until a predetermined time T2 elapses. Here, the value of the register REG4 is preset to the predetermined time T2, which is smaller than the predetermined time T3. At a point of time (g) in FIG. 3, the peripheral circuit P3 recognizes that the amount of data of the buffer BUF3 becomes smaller than the predetermined amount, and outputs the DMA transfer request R3 immediately. Here, the value of the register REG3 is preset to 0, which is smaller than the predetermined times T2 and T3. At a point of time (h) in FIG. 3, the local bus LBUS is occupied for the DMA transfer of the channel CH0. Accordingly, the channel CH1 can complete the DMA transfer twice within the predetermined period of time L2.

At a point of time (i) in FIG. 3, the peripheral circuit P4 recognizes the elapse of the predetermined time T2 and outputs the DMA transfer request R4. At a point of time (j) in FIG. 3, the local bus LBUS is occupied for the DMA transfer of the channel CH1 after the DMA transfer of the channel CH0 is completed. At a point of time (k) in FIG. 3, the peripheral circuit P5 recognizes the elapse of the predetermined time T3 and outputs the DMA transfer request R5. At a point of time (l) in FIG. 3, the local bus LBUS is occupied for the DMA transfer of the channel CH2 after the DMA transfer of the channel CH1 is completed.

As described above, by delaying the timings at which the peripheral circuits P4 and P5 output the DMA transfer requests R4 and R5, respectively, by the predetermined times T2 and T3, respectively, the channel CH0 reliably completes the DMA transfer twice within the predetermined period of time L1 even when the two low-speed peripheral circuits P4 and P5 are simultaneously operated. In addition, by setting the predetermined time T3 of the peripheral circuit P5 to be longer than the predetermined time T2 of the peripheral circuit P4, the DMA transfer of the channel CH1 can be prevented from being delayed due to an effect of the DMA transfer of the channel CH1.

As apparent from the above description, the first embodiment has the following effects.

Since the low-speed peripheral circuit delays the timing at which the data transfer request is output by the predetermined time, the DMAC 10d can receive the data transfer request from the high-speed peripheral circuit beforehand, which would originally be received after the data transfer request from the low-speed peripheral circuit is received. Accordingly, the data transfer response to the data transfer request from the low-speed peripheral circuit is exchanged with the data transfer response to the data transfer request from the high-speed peripheral circuit. As a result, even when a transfer request of data (moving picture data or audio data) that must be transferred within a predetermined period of time is output from the high-speed peripheral circuit, the data that must be transferred within the predetermined period of time can be reliably transferred.

Further, by providing the registers REG0 to REG5 for the peripheral circuits P0 to P5, respectively, a predetermined time until the data transfer requests R0 to R5 are actually output after they are ready to be output can be varied. Accordingly, the data transfer can cope with change of transfer rates of the peripheral circuits P0 to P5 and change of the number of receivable DMA transfer requests (i.e., the number of channels) in the DMAC 10d

Since the DMAC 10d rotates the priorities among the channels whenever the DMA transfer is performed by the predetermined amount, the DMA transfer can be reliably performed in response to any data transfer request assigned to the channels CH0 to CH2.

By setting the predetermined time of the low-speed peripheral circuit to be longer as its transfer rate becomes smaller, the data transfer responding to the data transfer request from the low-speed peripheral circuit having a large transfer rate can be prevented from being delayed due to an effect of the data transfer responding to the data transfer request from the low-speed peripheral circuit having a small transfer rate.

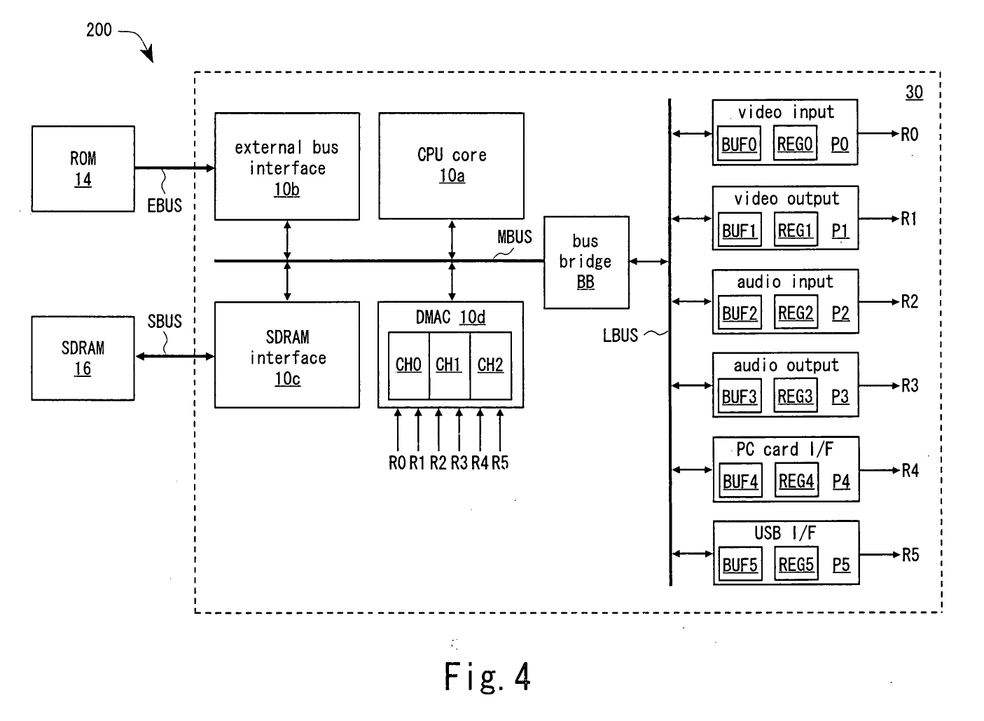

FIG. 4 is a block diagram illustrating a data transfer apparatus according to a second embodiment of the present invention. In FIG. 4, the same elements as the first embodiment are denoted by the same reference numerals, and detailed explanation will be omitted.

A data transfer apparatus 200 includes a semiconductor chip 30, a ROM 14, a SDRAM 16 (memory circuit), an external bus EBUS, and a bus SBUS for exclusive use of SDRAM.

The semiconductor chip 30 includes a CPU core 10a, an external bus interface 10b, a SDRAM interface 10c, a DMAC 10d (data transfer circuit), a bus bridge BB, peripheral circuits P0 to P5, a main bus MBUS, and a local bus LBUS (common bus). That is, in the data transfer apparatus 200, the DMAC 10d and the peripheral circuits P0 to P5 are formed on the same semiconductor chip 30. The data transfer apparatus 200 is operated in the same way as the data transfer apparatus 100 of the first embodiment where the DMAC 10d and the peripheral circuits P0 to P5 are formed in the separate semiconductor chips 10 and 20, except that both embodiments have different paths of the DMA transfer.

The bus bridge BB serves as an interface for exchanging data between the main bus MBUS and the local bus LBUS. Accordingly, in response to an assigned DMA transfer request, the channels CH0 to CH2 of the DMAC 10d perform the DMA transfer between buffers of the peripheral circuits to output the assigned DMA transfer request and the SDRAM 16 via the local bus LBUS, the main bus MBUS and the bus SBUS for exclusive use of the SDRAM 16.

As apparent from the above description, the second embodiment has the same effect as the first embodiment.

Although the examples where the peripheral circuit P4 (or the peripheral circuit P5) acts as the PC card interface (or the USB interface) have been explained in the first and second embodiments, the present invention is not limited to this. For example, the peripheral circuit P4 (or the peripheral circuit P5) may act as an 12C (Inter Integrated Circuit) interface not requiring a high speed for the DMA transfer between the buffer BUF4 (or the buffer BUF5) and the SDRAM 16.

The invention is not limited to the above embodiments and various modifications may be made without departing from the spirit and scope of the invention. Any improvement may be made in part or all of the components.

1. A data transfer apparatus comprising:
a common bus used for data transfer;
a memory circuit to which data is transferred via the common bus;
a plurality of peripheral circuits each having a corresponding buffer connected to the common bus and outputting respective data transfer requests depending on an amount of data of the corresponding buffer; and
a data transfer circuit performing data transfer between the memory circuit and the corresponding buffer in response to the respective data transfer requests, wherein
each low-speed peripheral circuit of the peripheral circuits except a high-speed peripheral circuit having the largest transfer rate outputs the data transfer request when a predetermined time has elapsed after the amount of data of the corresponding buffer became an amount sufficient to output the data transfer request, and
the high-speed peripheral circuit outputs the data transfer request when a time shorter than the predetermined time has elapsed after the amount of data of the corresponding buffer became the amount sufficient to output the data transfer request.

2. The data transfer apparatus according to claim 1, wherein
each of the low-speed peripheral circuits has a register setting the predetermined time, and outputs the data transfer request when the predetermined time set in the register has elapsed after the amount of data of the corresponding buffer became the amount sufficient to output the data transfer request.

3. The data transfer apparatus according to claim 1, wherein
the data transfer circuit preferentially performs data transfer responding to the data transfer request having the highest priority and rotates the priorities of the data transfer requests whenever the data transfer is performed by a predetermined amount.

4. The data transfer apparatus according to claim 1, wherein
the predetermined time of the low-speed peripheral circuit is set to be longer as a transfer rate thereof becomes smaller.

5. The data transfer apparatus according to claim 1, wherein
the high-speed peripheral circuit outputs the data transfer request immediately after the amount of data of the corresponding buffer becomes the amount sufficient to output the data transfer request.

6. The data transfer apparatus according to claim 1, wherein
the data transfer circuit is a direct memory access controller performing the data transfer by a direct memory access transfer.

7. The data transfer apparatus according to claim 1, wherein
one of the peripheral circuits, which has the buffer to which data is written by the data transfer, recognizes that the data transfer request is to be output when the amount of data of the buffer becomes smaller than a predetermined amount.

8. The data transfer apparatus according to claim 1, wherein
one of the peripheral circuits, which has the buffer from which data is read by the data transfer, recognizes that the data transfer request is to be output when the amount of data of the buffer becomes larger than a predetermined amount.

9. The data transfer apparatus according to claim 1, wherein
the data of the buffer of the high-speed peripheral circuit is moving picture data.

10. The data transfer apparatus according to claim 1, wherein
the data of the buffer of the high-speed peripheral circuit is audio data.

11. The data transfer apparatus according to claim 1, wherein
the peripheral circuits and the data transfer circuit are formed on separate semiconductor chips.

12. The data transfer apparatus according to claim 1, wherein
the peripheral circuits and the data transfer circuit are formed on the same semiconductor chip.
